(19) United States
(12) Patent Application Publication
(10) Pub. No.: US 2004/0206244 A1
(43) Pub. Date: Oct. 21, 2004

(54) Kitchen mixing faucet for producing soda water

(76) Inventors: Pasquale Spiegel, Glinde (DE); Margret Spiegel, Glinde (DE)

Correspondence Address: HENRY M FEIEREISEN, LLC, 350 FIFTH AVENUE, SUITE 4714, NEW YORK, NY, 10118, US

(21) Appl. No.: 10/842,135

(22) Filed: May 10, 2004

Related U.S. Application Data
(63) Continuation of application No. 10/031,777, filed on Jun. 11, 2002, now abandoned.
Application No. 10/031,777 is a 371 of international application No. PCT/DE00/02437, filed on Jul. 24, 2000.

(30) Foreign Application Priority Data
Jul. 23, 1999 (DE) 199 34 061.7

(51) Int. Cl. A23L 2/54

(52) U.S. Cl. 99/323.2

(57) ABSTRACT

The invention relates to a kitchen mixing unit (1) which has an inlet for hot water (5) an inlet for cold water (6) and a mixer connection (9) for carbon dioxide, whereby CO₂ can be added to drinking water in order to produce soda, to which syrups can also be added and wherein a filter and a cooling device can also both be connected upstream of the water inlet.

The invention relates to a mixing faucet and a novel mixing system for mixing CO₂ with water (fluids) and to draw soda water from a water faucet having at least one cold water supply.

Water tap connections as used especially in kitchens and private households usually comprise a mixing faucet having a cold water inlet and a hot water inlet. A water line for supplying water to the dishwasher and the washing machine can also be included. Hot-and cold water can be drawn from a spout. The known two-lever faucets are operated through two separate valves or, when using a one-lever mixing faucet, are operated via a common lever.

Devices for home production of drinking water or, respectively cold water which has been mixed with CO₂, are known, for example, those filled with cold water where CO₂ is supplied to a storage container by means of a CO₂ cartridge. The carbonated drinking water is prepared with the high-pressure of CO₂. This process becomes very cumbersome when producing larger quantities and through the loss of CO₂ which occurs during preparation, this method is rendered unnecessarily cumbersome and expensive.

An object of the present invention is to thus modify the known mixing faucet in connection with a novel mixing system by means of a static or mechanical mixer in such a way that drinking water with a high concentration of CO₂ can be drawn in a simple matter and inexpensively from a normal household water tap connection, and comparable in quality to the bottled soda water commercially available, but with the difference that it is less expensive to produce and that it can be drawn from the spout of the regular water faucet.

This object is solved in accordance with the present invention wherein the drawing channel with its integrated cylinder can produce the counterpressure, which is necessary for an optimal carbonization. The novel mixing faucet (water tap connection) comprises a tap, which is located inside, or outside the water tap connection for drawing carbonated water (fluids) which is drawn through the normal spout. Drawing of drinks should be understood as the possibility to utilize the water tap connection (mixing faucet) for normal cold water or warm water (mixed water). In addition, it is also possible to draw drinking water mixed with CO₂ through the particular configuration of this mixing fixture (tap valve) to draw water that has been mixed with CO₂. (Not shown here)

In accordance with a preferred embodiment of the invention, it is possible to construct the water tap connection in such a manner that the carbonized drinking water is drawn through a bore within the body of the faucet in a pre-determined draw. This bore (passage) ends within the regular spout of the respective faucet.

A further object of the invention is that in the passage channel for the carbonated drinking water, prior to reaching the faucet spout first hits a cylindrical body which is disposed within the outlet channel. When hitting the cylindrical body, the carbonated water stream becomes calmed which is necessary to realize the least amount of loss of CO₂ dissolved in the water.

A further object of the invention is that the cylinder which is disposed in the channel leading to the faucet spout for carbonated water, is also used to raise a certain counterpressure which is necessary for the production of carbonated water. The respective counterpressure is computed from the amount of fluid (water) to be mixed per minute, preferably drinking water (mineral water) with CO₂ or other gases.

It is another object of the invention that the CO₂ can also be generated by means other than only via the special valve for operating the release of CO₂.

Further object of the invention is, that the supply line which supplies the fixture (faucet valve) with carbonated drinking water is attached by a threaded screw to this special fixture and has to be made from materials that are compatible with nutritional standards or from coatings of that type. By means of the threaded connection of the line, insertion of the respective cylinder for the fixture is realized.

Further object of the invention is that the supply line for the carbonated water, supplies carbonated water. At the opposite side of the supply line a static mixer is disposed; the preferred mixer is of the type already subject of a patent application No. 198 513 60.7 filed by the inventor. Other static mixers or other methods for carbonization of drinking water can also b utilized, in order to draw carbonated water via the novel fixture.

In accordance with a further preferred embodiment of the invention, the supply line which provides the connection of the fixture and the static mixer or other mixing principles is provided with an exchangeable pressure valve against excessive pressure, which could occur through a defect in either the CO₂ container, or the water pressure reducing valve (flow through volume control), so that pressure can be released to prevent damage of the fixture. When damage occurs, the replaceable pressure valve can be quickly exchanged.

In accordance with a further preferred embodiment of the invention, the cylinder for opening and closing and for the respective counterpressure from the fixture side against the water stream for carbonization of the water is indexed in toothed configuration or other means for opening the cylinder to such an extent, so that, if desired, the flow volume per minute of carbonated drinking water (fluids) can be raised. This has the advantage that the user of this fixture (tap valve) can draw a variety of soda water of different strength (classic, medium, light). This can be of a great utility for a family. Especially one with children. When drawing medium strength, a variety of flavorings can be added for obtaining an inexpensive and refreshing drink.

In accordance with a preferred embodiment of the invention, when the cylinder from which the carbonated water is drawn, is inserted into the fixture form the bottom side, a connection between the cylinder and the side where the operating valve is located can be realized by means of a rod assembly. Since the rod assembly is also indexed in a toothed configuration, opening and closing of the cylinder can be realized by turning the valve. When screwing the operating valve into the body of the fixture, the rod assembly and the cylinder are firmly connected for optimal operation.

In accordance with a preferred embodiment of the invention, the operating valve necessary for opening an closing of the cylinder is indexed for operation so that is possible for the user of the fixture to adjust the setting for the desired quality of the soda water. The operating valve for opening and closing can be activated by a turning- or other mechanism.

In accordance with a preferred embodiment of the invention, the materials, which are coming in contact with CO₂ and carbonated water, must be from materials compatible with nutritional standards.

In accordance with preferred embodiment of the invention, a filter system can be installed upstream of the static mixer and before entering of the drinking water in order to ensure good quality of the drinking water.

In accordance with a preferred embodiment of the invention, the principle of the drawing carbonated water (fluids) is described by the inventor in this patent application. The principle of drawing should also have application fields for patent applications already filed by the inventor and that have been deposited in the patent office with the following numbers: 198 101 43.0, 198 299 26.5, 108 496 28.1, 198 062 34.5, 297 148 72.9, 298 042 32.0 and PCT/DE98/02413.

A further advantageous embodiment of the invention, which also has separate inventive status, the drawing method as described here by the inventor and ensuring a good carbonization can also be realized outside of the fixture (faucet valve) and carbonized drinking water can also be drawn from the regular faucet spout. Or, this can also be separate.

In a further advantageous embodiment, which has also separate inventive status, the water pressure reducing valve (flow volume control) is provided upstream of the static mixer and configured possibly as a manual control in order to regulate the flow volume of the drinking water and in order to realize a fine adjustment of the water stream at the water spout. The same principle applies on the side of CO₂ upstream of the static mixer, to likewise realize a fine adjustment for optimal function of the fixture and to ensure the drawing of carbonized water.

In a further advantageous embodiment of the invention, the principle of drawing carbonized water (fluids), which can be gleaned from the foregoing description can be used for other applications (beverage industry in general, not shown here).

In according with a preferred embodiment of the invention, the drawing of soda water can be from a separate spout at the special fixture (second spout). Not shown here.

In accordance with a preferred embodiment, the seat of the cylinder and the cylinder itself are of a conical shape and the cylinder can be of varying diameter and length depending on the field of application. Not shown here.

In accordance with a preferred embodiment of the invention, it is possible to draw the soda water or also the filtered water via the cartridge control or via ceramic disks or other materials (not shown here). Drawing can also be realized through the regular faucet spout or also through a separate line within the faucet spout, in which case then via the entire afore-mentioned system, in order to prepare the soda water.

According to a further advantageous embodiment of the invention, which also has separate inventive status, the soda water can be drawn by means of a novel mixing method in connection with a novel fixture, thus enabling to draw water (fluids) mixed with CO₂.

According to a further advantageous embodiment of the invention, which has a separate inventive status, the cylinder, which ensures a good quality of the soda water and ensures the respective flow volume of soda water, is directly mounted into the faucet spout. This cylinder can also be configured in a conical shape, as can be the wall into which the cylinder is integrated. (Not shown here).

According to a further advantageous embodiment of the invention, and which also has a separate inventive status, the entire control of CO₂ and the fluids (water) can be effected through magnetic valves. (Not shown here).

According to a further advantageous embodiment of the invention, and which has also a separate inventive status, a novel mixing system is provided for preparing soda water by means of a mechanical system capable of providing the novel system with CO₂. (Not shown here).

According to a further advantageous embodiment of the invention, the user of the novel fixture can be provided with refreshing concentrates; (commercially available), in order to change the soda water drawn from the novel mixing system together with the concentrates into a refreshing drink. These concentrates are then brought to market under the same name adopted for the fixture with the novel mixing system. (Concentrate and fixture have identical names). Not shown here.

According to a further advantageous embodiment of the invention, the cylinder with the cylinder guide and the connector part to the static mixer can be mounted separately to the novel fixture and drawing of soda water at the fixture can be effected by mechanical means. (Not shown here).

In accordance with a further advantageous embodiment of the invention, the afore-described cylinder (which can be also of conical shape) is integrated into the static mixer and mounted to the novel fixture through a connection line. (Not shown here).

In accordance with an advantageous embodiment of the invention, the afore-described fixture (one-lever faucet valve) with novel arrangement can also be configured as a two-levered fixture; wherein in conjunction with the novel mixing system, CO₂ is mixed with fluids (water). (Not shown here).

In accordance with a further advantageous embodiment of the invention, it is possible to also only draw cooled and filtered fluids (water) with the new fixture, whereby a cooling system (flow-through cooler preferred) is provided upstream of the mixing system (not shown here). The cooled and filtered water can be either mixed with CO₂, or it can also be drawn having no CO₂ content. (Not shown here).

In accordance with a further embodiment of the invention, the cylinder (which can also be conical) where it is hit by the mixed soda water is directly connected to the valve, such that through operation of the valve it is possible to draw from it directly. This special valve can also serve as the valve to relieve any overpressure. (Not shown here).

In a further embodiment of the invention, the special afore-described special fixture is operated with a mechanical mixer.

In a further embodiment of the invention, the drawing valves (one- or two-levered fixtures) can be configured with swiveling spouts.

In a further embodiment of the invention, the novel mixing system and the novel mixing fixture are provided with replaceable CO₂ cartridges. (Not shown here).

In further embodiment of the invention, the water and CO₂ pressure control is configured as a unit and by suitable adjustments the dosing of water and CO is thereby ensured. This novel pressure control is provided upstream of the mixer. Thus, good quality of the soda is realized, even during varying water pressure. The mixing system and the novel fixture can also be provided with separate pressure controls. (Not shown here).

In accordance with a further preferred embodiment of the invention, the novel mixing system (static or mechanical mixer), water (fluids) is provided through a separate supply line or a branch line. (Not shown here).

Further details of the invention will become clear from the following description and the accompanying drawings, in which exemplary preferred embodiments of the invention are shown.

The drawing shows:

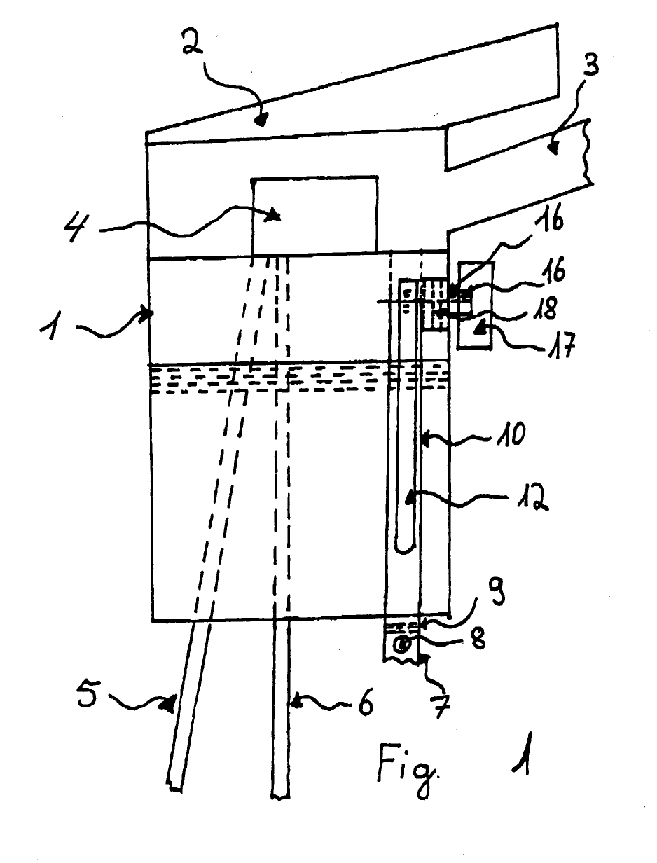

FIG. 1: a schematic representation of the composition faucet configured as a one lever-mixing faucet.

A mixing battery (1) comprises essentially a water tap connection (3) a cold water supply line (6) and a hot water supply line (5) and a second cold water supply line (not shown here).

A one-hand lever (2) of a cartridge (4) or disk control. (Not shown).

A cylindrical body (12), which can be configured in a conical shape, includes the wall (11).

A connection means (9) for the static mixer or the mechanical mixer. (Not shown)

Auxiliary overpressure valve (8) seat of the opening valve (18) indexing means (16) (16) for varying adjustments for the desired soda quality.

Valve (17) for drawing the soda water stream, also to be utilized as an over pressure valve (17). Soda water can also be drawn from a swiveling water spout (3).

The cylinder (12) can be utilized by means of a mechanical connection to the operating valve (17) for opening and closing the soda water stream. By means of a connection line (7) to the novel static mixer (not shown), soda water or filtered water is supplied to the mixing fixture (1). A passage channel (10) is provided where the cylinder (12) is disposed and ending in a faucet spout (3).

The novel mixing fixture (1) can now be connected too the cold water (6) and hot water (5) main water system. (Not shown). Likewise, for producing soda water with the novel mixing system it is connected to the connector means (9) by means of a screw, a threaded screw or other possible fastening means (not shown).

After the novel mixing fixture, including the novel mixing system (not shown) is properly installed and the pressure controls adjusted for the water volume to be drawn (not shown), soda water can then be drawn via an operating valve (17) from the spout (3) of the fixture (1).

The user of the mixing fixture (1) can draw noticeably different qualities of soda water through indexing means (16) (16) on the operating valve (17) of the novel mixing fixture from the faucet spout (3) of the fixture (1)

The faucet spout for the soda water can also be separate from the regular faucet spout (3) (not shown).

The auxiliary supply of cold water for the novel mixing system (static and mechanical mixer) (not shown) and the novel mixing fixture (1) is supplied from either the main water line or from a branch of the same (not shown)

Upstream of the static mixer (or the mechanical one) (not shown), a pressure control for water is installed (not shown) to a so-called T-piece (not shown) connects the supply line, which leads to a CO₂ pressure control (not shown); a replaceable CO₂ cartridge can be disposed to the CO₂ pressure control (not shown).

Furthermore, other possible upstream connections of the mixing system can be installed for cooling the water or a filter system in order to filter the water (not shown).

The novel mixer (novel mixing method) can be disposed to the novel mixing fixture (1) upstream of these afore-described connection of water, CO₂, cooling unit and the water filter system.

A separate faucet spout for soda water (not shown) can be utilized for all possible faucet valves or mixing fixtures, especially those provided with the novel mixing system however, this is not a prerequisite.

The drawing of soda water can be also modified by means of the regular operation means (2) so that by means of the cartridge (4) or the disk control (not shown) drawing from the faucet spout (3) or separate faucet spout (not shown) is possible.

The novel fixture (1) is to be constructed, so that the faucet spout (3) of the separate spout is a swiveling spout. (Not shown).

As a further variation in order to draw soda water from the mixing fixture (1), the cylinder (12) can be integrated into the faucet spout (3), or a separate faucet spout (not shown). When utilizing a separate faucet spout (not shown) with an integrated cylinder (12) through a ball valve or other opening and closing mechanisms, cooled and filtered soda water can also be drawn (not shown) from the novel mixing fixture.

The valve 17 of the novel mixing fixture (1) is to be constructed in such a manner that it is gas and watertight. This is generally applicable and necessary for all drawing valves from which soda water produced with my novel system is drawn via a drawing valve, however other solutions can also be applied here.

When the valve (17) is closed by means of a magnet or other type of non-return valve (not shown), they must each be mounted as closely as possible to the mixing system (static or mechanical mixer), for interrupting the water stream and the CO₂ stream in the direction of the mixing system. The interruption is released automatically, when the valve (17) for the soda water drawing is opened.

When using magnetic valves, the control can be integrated into valve (17) but other means of controls can also be used.

In the afore-described methods to produce soda water by means of the novel mixer (not shown) in connection with the novel mixing fixture of (1), the necessary CO₂ supply for the novel mixing system 1 could also be effected by means of mechanically feeding the CO₂ into the water stream upstream of the mixing system (not shown).

By means of a filter system upstream of the mixing system (not shown), the user of the novel mixing fixture (1) can be offered water of good quality even when it is not mixed with CO₂ (carbon dioxide).

Using a cooling device (not shown) upstream of the mixing system and the filter system, or downstream of the filter system is highly luxurious. Apart form the high water temperatures occurring in summer, high uptake of CO₂ in water is always effected thereby.

The novelty of the mixing fixture (1) is perhaps that normal cold water or warm water or mixed water can be drawn by means of the fixture (1). Likewise, soda water of high quality enriched with CO₂ can be drawn, which is suitable for preparing refreshing beverages by adding the respective syrups to the soda water drawn from faucet spout (3) or a separate faucet spout (not shown).

1. Mixing faucet and method for mixing CO₂ with water and for drawing soda water via a faucet spout (3) comprising, a water faucet with at least one cold water supply line (6) characterized in that this is connectable to a static or mechanical mixer and connected with a CO₂ pressure control, a water pressure reducing valve and a CO₂ supply.

2. Mixing faucet and method for mixing CO₂ with water and for drawing soda water via a faucet spout (3) according to claim 1, characterized in that the faucet valve comprises a second cold water supply line (6) and also a hot water line (5).

3. Mixing faucet and method for mixing CO₂ with water and for drawing soda water via a faucet spout (3) according to claim 1, characterized in that the fixture is a one lever-(1) or a two-lever fixture (faucet valve).

4. Mixing faucet and method for mixing CO₂ with water and for drawing soda water via a faucet spout (3) according to claim 1, characterized in that the mixing faucet (1) is connected to the novel mixing system (static or mechanical mixer) (9).

5. Mixing faucet and method for mixing CO₂ with water and for drawing soda water via a faucet spout (3) according to claim 1, characterized in that the static or mechanical mixer is provided with a CO₂ pressure control and water pressure reducing valve having connecting means.

6. Mixing faucet and method for mixing CO₂ with water and for drawing soda water via a faucet spout (3) according to claim 1, characterized in that the water pressure reducing valve can be connected to the main water system or a branch line.

7. Mixing faucet and method for mixing CO₂ with water and for drawing soda water via a faucet spout (3) according to claim 1, characterized in that the CO₂ pressure reducing valve comprises a CO₂ replaceable cartridge and a special snap closure.

8. Mixing faucet and method for mixing CO₂ with water and for drawing soda water via a faucet spout (3) according to claim 1, characterized in that a filter system is placed upstream of the static or mechanical mixer.

9. Mixing faucet and method for mixing CO₂ with water and for drawing soda water via a faucet spout (3) according to claim 1, characterized in that a cooling unit is provided in conjunction with the static or mechanical mixer upstream of downstream from the filter system.

10. Mixing faucet and method for mixing CO₂ with water and for drawing soda water via a faucet spout (3) according to claim 1, characterized in that a combined CO₂ and water pressure reducing valve can be used to realize the precise supply of water for supplying the novel mixing system.

11. Mixing faucet and method for mixing CO₂ with water and for drawing soda water via a faucet spout (3) according to claim 1, characterized in that the water side and the CO₂ side can be locked in opposite direction of the flow direction the novel mixer by means of a magnet- or mechanical over pressure control.

12. Mixing faucet and method for mixing CO₂ with water and for drawing soda water via a faucet spout (3) according to claim 1, characterized in that maintaining a certain volume of water and respective volume of CO₂ while simultaneously maintaining water pressure and CO₂ pressure in the flow direction of the fixture (1) via line (7) into the drawing channel (10) the soda water enters into the drawing channel (10), where it is hitting the cylinder (12) and then being released through the operating valve (17) by opening the valve (17) for passing through the faucet spout.

13. Mixing faucet and method for mixing CO₂ with water and for drawing soda water via a faucet spout (3) according to claim 1, characterized in that the cylinder and the cylinder wall have a conical shape.

14. Mixing faucet and method for mixing CO₂ with water and for drawing soda water via a faucet spout (3) according to claim 1, characterized in that the cylinder has mechanical elements (13)(14)(15) for opening and closing by means of the operating valve (17).

15. Mixing faucet and method for mixing CO₂ with water and for drawing soda water via a faucet spout (3) according to claim 1, characterized in that the operating valve can also serve as the overpressure valve.

16. Mixing faucet and method for mixing CO₂ with water and for drawing soda water via a faucet spout (3) according to claim 1, characterized in that the operating valve (17) can be screwed into the fixture (1).

17. Mixing faucet and method for mixing CO₂ with water and for drawing soda water via a faucet spout (3) according to claim 1, characterized in that the operating valve (17) is provided with indexing means (16) (16).

18. Mixing faucet and method for mixing CO₂ with water and for drawing soda water via a faucet spout (3) according to claim 1, characterized in that the soda water is drawn from a separate spout.

19. Mixing faucet and method for mixing CO₂ with water and for drawing soda water via a faucet spout (3) according to claim 1, characterized in that the soda water can be guided by means of the cartridge (4) control into the spout (3) or via a separate spout.

20. Mixing faucet and method for mixing CO₂ with water and for drawing soda water via a faucet spout (3) according to claim 1, characterized in that drawing is not carried out by means of the operating valve (17).

21. Mixing faucet and method for mixing CO₂ with water and for drawing soda water via a faucet spout (3) according to claim 1, characterized in that that the water is drawn by means of the operating valve (17).

22. Mixing faucet and method for mixing CO₂ with water and for drawing soda water via a faucet spout (3) according to claim 1, characterized in that the operating valve (17) and the operating part (2) can also be used to only draw water.

23. Mixing faucet and method for mixing CO₂ with water and for drawing soda water via a faucet spout (3) according to claim 1, characterized in that filtered and cooled water without any CO₂ can be drawn by means of the operating part (valves)(17)(2).

24. Mixing faucet and method for mixing CO₂ with water and for drawing soda water via a faucet spout (3) according to claim 1, characterized in that the filtered and cooled soda water are drawn by means of the operating parts (valves)(17)(2) through the spout.

25. Mixing faucet and method for mixing CO₂ with water and for drawing soda water via a faucet spout (3) according to claim 1, characterized in that filtered and cooled water but also non-cooled and unfiltered water can be drawn from by means of the operating valve. (17)(2).

26. Mixing faucet and method for mixing CO₂ with water and for drawing soda water via a faucet spout (3) according to claim 1, characterized in that filtered and cooled water as well as cooled and filtered water mixed with CO₂ can be drawn from the separate faucet spout of the fixture.

27. Mixing faucet and method for mixing CO₂ with water and for drawing soda water via a faucet spout (3) according to claim 1, characterized in that the cylinder (12) can be integrated directly into the faucet spout (3) or the separate faucet spout of the fixture.

28. Mixing faucet and method for mixing CO₂ with water and for drawing soda water via a faucet spout (3) according to claim 1, characterized in that the cylinder (12) is integrated into the static mixer.

29. Mixing faucet and method for mixing CO₂ with water and for drawing soda water via a faucet spout (3) according to claim 1, characterized in that the faucet spout is a swiveling faucet spout.

30. Mixing faucet and method for mixing CO₂ with water and for drawing soda water via a faucet spout (3) according to claim 1, characterized in that a one lever or two lever mixing faucet can be provided with a swiveling spout (generally all faucets)

31. Mixing faucet and method for mixing CO₂ with water and for drawing soda water via a faucet spout (3) according to claim 1, characterized in that the operating valve (17) has an integrated cylinder (12).

32. Mixing faucet and method for mixing CO₂ with water and for drawing soda water via a faucet spout (3) according to claim 1, characterized in that the integrated cylinder (12) at the operating valve can also be configured in a conical shape.

33. Mixing faucet and method for mixing CO₂ with water and for drawing soda water via a faucet spout (3) according to claim 1, characterized in that the novel mixing fixture (1) (faucet valve) is provided with a special name. This name is then retained for the special syrups necessary for the refreshing drinks.

34. Mixing faucet and method for mixing CO₂ with water and for drawing soda water via a faucet spout (3) according to claim 1, characterized in that the novel mixing fixture (1) is so configured as to effect sufficient counterpressure to the static mixer of the mechanical mixer.

35. Mixing faucet and method for mixing CO₂ with water and for drawing soda water via a faucet spout (3) according to claim 1, characterized in that other types of cylinders may also be utilized.

36. Mixing faucet and method for mixing CO₂ with water and for drawing soda water via a faucet spout (3) according to claim 1, characterized in that the over pressure valve is integrated into the line (7).

37. Mixing faucet and method for mixing CO₂ with water and for drawing soda water via a faucet spout (3) according to claim 1, characterized in that the cylinder can also be utilized as a seal against the stream of soda water.

38. Mixing faucet and method for mixing CO₂ with water and for drawing soda water via a faucet spout (3) according to claim 1, characterized in that the novel mixing system via (static and mechanical mixer) to mix (carbonate) CO₂ with water (fluids, mineral water) can also be utilized in drink outlets of every type.
